(19) United States
(12) Patent Application Publication
(10) Pub. No.: US 2024/0300493 A1
(43) Pub. Date: Sep. 12, 2024

(54) CONTROL DEVICE FOR VEHICLE

(71) Applicant: Toyota Jidosha Kabushiki Kaisha, Toyota-shi (JP)

(72) Inventor: Taisuke HAYASHI, Toyota-shi (JP)

(73) Assignee: Toyota Jidosha Kabushiki Kaisha, Toyota-shi (JP)

(21) Appl. No.: 18/585,220

(22) Filed: Feb. 23, 2024

(30) Foreign Application Priority Data
Mar. 6, 2023 (JP) 2023-033637

(51) Int. Cl. B60W 30/14; B60W 30/165; B60W 50/00; B60W 50/14

(52) U.S. Cl. CPC B60W 30/143; B60W 30/165; B60W 50/0097; B60W 50/14; B60W 2050/146; B60W 2552/15; B60W 2554/802; B60W 2556/45

(57) ABSTRACT

A control device for a vehicle is configured to: acquire a slope at a current location, the current location being a point where the vehicle is located; acquire a slope at a preceding location, the preceding location being a point ahead of the current location in a travel direction of the vehicle; compare the slope at the current location and the slope at the preceding location; and increase a driving force of the vehicle on condition that the slope at the preceding location is greater than the slope at the current location by a predetermined value determined in advance or more.

### CROSS-REFERENCE TO RELATED APPLICATION

This application claims priority to Japanese Patent Application No. 2023-033637 filed on Mar. 6, 2023, incorporated herein by reference in its entirety.

### BACKGROUND

### 1. Technical Field

The present disclosure relates to control devices for vehicles.

### 2. Description of Related Art

A control device for a vehicle disclosed in Japanese Unexamined Patent Application Publication No. 2019-142429 (JP 2019-142429 A) sets a speed upper limit value distribution in a predetermined area around a preceding vehicle when there is a preceding vehicle traveling ahead of the vehicle. The speed upper limit value distribution defines the upper limit value of the relative speed between the vehicle and the preceding vehicle. The control device disclosed in JP 2019-142429 A increases the upper limit value of the relative speed as the slope at the current location of the vehicle is greater.

### SUMMARY

The greater the slope of the road on which the vehicle is traveling, the larger the driving force required for the vehicle to travel. Therefore, if the driving force of the vehicle is constant, the speed of the vehicle decreases at a point where the slope of the road increases. Such a decrease in speed of the vehicle may cause traffic congestion at the point where the slope of the road increases. In the control device disclosed in JP 2019-142429 A, the upper limit value of the relative speed changes according to the slope of the road. However, JP 2019-142429 A does not focus on how the driving force of the vehicle should be controlled according to the slope of the road.

A first aspect of the present disclosure is a control device for a vehicle. The control device includes a processor. The processor is configured to: acquire a slope at a current location, the current location being a point where the vehicle is located; acquire a slope at a preceding location, the preceding location being a point ahead of the current location in a travel direction of the vehicle; compare the slope at the current location and the slope at the preceding location; and increase a driving force of the vehicle on condition that the slope at the preceding location is greater than the slope at the current location by a predetermined value determined in advance or more.

In the first aspect, the processor may be configured to acquire a following distance from the vehicle to a preceding vehicle traveling ahead of the vehicle. The processor may be configured to increase the driving force of the vehicle on condition that the slope at the preceding location is greater than the slope at the current location by the predetermined value or more and that the following distance is equal to or greater than a prescribed distance determined in advance.

In the first aspect, the processor may be configured to notify a user of the vehicle when increasing the driving force of the vehicle in response to the slope at the preceding location being greater than the slope at the current location by the predetermined value or more.

In the first aspect, the processor may be configured to associate a slope at a specific point with the driving force of the vehicle at the specific point. The processor may be configured to send information associating the slope at the specific point with the driving force of the vehicle at the specific point to outside. The specific point may be a point where the vehicle has traveled.

A second aspect of the present disclosure is a control device for a vehicle. The control device includes a processor. The processor is configured to: acquire a slope at a current location, the current location being a point where the vehicle is located; store the acquired slope at the current location for a certain period determined in advance; compare the acquired slope at the current location and a slope at a travel point out of the stored slopes at the current locations, the travel point being a point located in an opposite direction to a travel direction of the vehicle; and increase a driving force of the vehicle on condition that the acquired slope at the current location is greater than the slope at the travel point by a predetermined value determined in advance or more.

According to the first aspect and the second aspect, the driving force of the vehicle increases near a point where the slope of the road increases. As a result, it is possible to reduce the occurrence of traffic congestion due to a decrease in speed of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a schematic configuration of an information processing system;

FIG. 2 is a functional block diagram showing a basic configuration of a motion manager; and

FIG. 3 is a flowchart showing driving force adjustment control.

### DETAILED DESCRIPTION OF EMBODIMENTS

### Schematic Configuration of Information Processing System

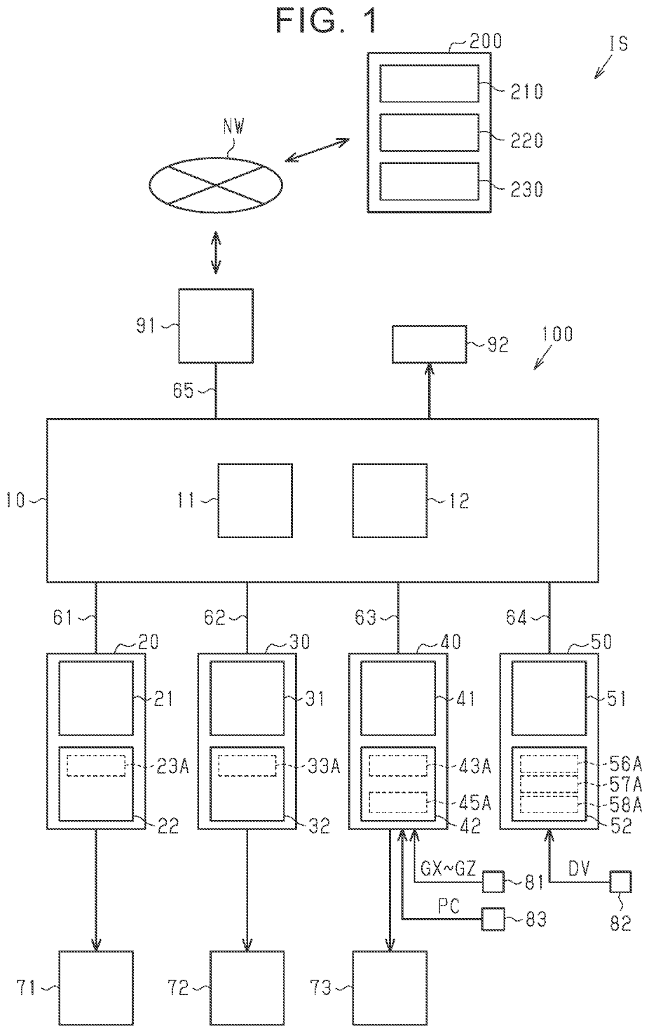

An embodiment of the present disclosure will be described below with reference to FIGS. 1 to 3. First, a schematic configuration of an information processing system IS will be described.

As shown in FIG. 1, the information processing system IS includes a vehicle 100. The vehicle 100 includes a powertrain device 71, a steering system 72, and a brake device 73.

The powertrain device 71 includes an engine, a motor generator, and a transmission. The engine can apply a driving force to drive wheels of the vehicle 100 via the transmission. The motor generator can apply a driving force to the drive wheels of the vehicle 100 via the transmission.

An example of the steering system 72 is a rack and pinion electric steering system. The steering system 72 can change the orientation of steered wheels of the vehicle 100 by controlling a rack and a pinion, not shown.

The brake device 73 is a so-called mechanical brake device that mechanically brakes wheels of the vehicle 100. In the present embodiment, an example of the brake device 73 is a disc brake.

As shown in FIG. 1, the vehicle 100 includes a central ECU 10, a powertrain ECU 20, a steering ECU 30, a brake ECU 40, and an advanced driver assistance ECU 50. The vehicle 100 also includes a first external bus 61, a second external bus 62, a third external bus 63, a fourth external bus 64, and a fifth external bus 65. The term “ECU” is an abbreviation for “electronic control unit.”

The central ECU 10 centrally controls the entire vehicle 100. The central ECU 10 includes an execution device 11 and a storage device 12. An example of the execution device 11 is a central processing unit (CPU). The storage device 12 includes a read-only memory (ROM) that can only be read, a volatile random access memory (RAM) that can be read and written, and a nonvolatile storage that can be read and written. The storage device 12 stores various programs and various types of data in advance. The execution device 11 implements various processes by executing the programs stored in the storage device 12.

The powertrain ECU 20 can communicate with the central ECU 10 via the first external bus 61. The powertrain ECU 20 controls the powertrain device 71 by outputting control signals to the powertrain device 71. The powertrain ECU 20 includes an execution device 21 and a storage device 22. An example of the execution device 21 is a CPU. The storage device 22 includes a ROM, a RAM, and a storage. The storage device 22 stores various programs and various types of data in advance. The storage device 22 also stores a powertrain application 23A as one of the various programs in advance. The powertrain application 23A is application software for controlling the powertrain device 71. The execution device 21 implements a function as a powertrain control unit 23, which will be described later, by executing the powertrain application 23A stored in the storage device 22.

The steering ECU 30 can communicate with the central ECU 10 via the second external bus 62. The steering ECU 30 controls the steering system 72 by outputting control signals to the steering system 72. The steering ECU 30 includes an execution device 31 and a storage device 32. An example of the execution device 31 is a CPU. The storage device 32 includes a ROM, a RAM, and a storage. The storage device 32 stores various programs and various types of data in advance. The storage device 32 also stores a steering application 33A as one of the various programs in advance. The steering application 33A is application software for controlling the steering system 72. The execution device 31 implements a function as a steering control unit 33, which will be described later, by executing the steering application 33A stored in the storage device 32.

The brake ECU 40 can communicate with the central ECU 10 via the third external bus 63. The brake ECU 40 controls the brake device 73 by outputting control signals to the brake device 73. The brake ECU 40 includes an execution device 41 and a storage device 42. An example of the execution device 41 is a CPU. The storage device 42 includes a ROM, a RAM, and a storage. The storage device 42 stores various programs and various types of data in advance. The storage device 42 also stores a brake application 43A as one of the various programs in advance. The brake application 43A is application software for controlling the brake device 73. The storage device 42 further stores a motion manager application 45A as one of the various programs in advance. The motion manager application 45A is application software for arbitrating a plurality of motion requests. The execution device 41 implements a function as a brake control unit 43, which will be described later, by executing the brake application 43A stored in the storage device 42. The execution device 41 also implements a function as a motion manager 45, which will be described later, by executing the motion manager application 45A stored in the storage device 42. In the present embodiment, the brake ECU 40 is a control device for the vehicle 100.

The advanced driver assistance ECU 50 can communicate with the central ECU 10 via the fourth external bus 64. The advanced driver assistance ECU 50 perform various types of driver assistance. The advanced driver assistance ECU 50 includes an execution device 51 and a storage device 52. An example of the execution device 51 is a CPU. The storage device 52 includes a ROM, a RAM, and a storage. The storage device 52 stores various programs and various types of data in advance. The various programs include a first assistance application 56A, a second assistance application 57A, and a third assistance application 58A. An example of the first assistance application 56A is application software for collision damage mitigation braking that automatically applies braking to mitigate collision damage to the vehicle 100, that is, so-called autonomous emergency braking (AEB). An example of the second assistance application 57A is application software for so-called lane keeping assist (LKA) that keeps the vehicle 100 in its lane. An example of the third assistance application 58A is application software for so-called adaptive cruise control

(ACC) that allows the vehicle 100 to travel while maintaining a constant following distance from a preceding vehicle traveling ahead of the vehicle 100. In the present embodiment, the first assistance application 56A, the second assistance application 57A, and the third assistance application 58A are each application software that implements driver assistance functions of the vehicle 100. The execution device 51 implements a function as a first assistance unit 56, which will be described later, by executing the first assistance application 56A stored in the storage device 52. The execution device 51 also implements a function as a second assistance unit 57, which will be described later, by executing the second assistance application 57A stored in the storage device 52. The execution device 51 implements a function as a third assistance unit 58, which will be described later, by executing the third assistance application 58A stored in the storage device 52.

As shown in FIG. 1, the vehicle 100 includes an acceleration sensor 81, a following distance sensor 82, and a GNSS receiver 83. The acceleration sensor 81 is a so-called three-axis sensor. That is, the acceleration sensor 81 can detect a longitudinal acceleration GX, a lateral acceleration GY, and a vertical acceleration GZ. The longitudinal acceleration GX is an acceleration along a longitudinal axis of the vehicle 100. The lateral acceleration GY is an acceleration along a lateral axis of the vehicle 100. The vertical acceleration GZ is an acceleration along a vertical axis of the vehicle 100. The following distance sensor 82 detects a following distance DV that is a distance from the vehicle 100 to a preceding vehicle traveling ahead of the vehicle 100. An example of the following distance sensor 82 is a LIDAR sensor. The term “LIDAR” is an abbreviation for “Laser Imaging Detection and Ranging.” The GNSS receiver 83 detects location coordinates PC, namely coordinates of a point where the vehicle 100 is located, through communication with GNSS satellites, not shown. The term “GNSS” is an abbreviation for “Global Navigation Satellite System.”

The brake ECU 40 acquires signals indicating the longitudinal acceleration GX, the lateral acceleration GY, and the vertical acceleration GZ from the acceleration sensor 81. The brake ECU 40 also acquires a signal indicating the location coordinates PC from the GNSS receiver 83. The advanced driver assistance ECU 50 acquires a signal indicating the following distance DV from the following distance sensor 82. The brake ECU 40 can also acquire various values including the following distance DV via the central ECU 10.

As shown in FIG. 1, the vehicle 100 includes a DCM 91 and a display 92.

The DCM 91 is connected to the central ECU 10 via the fifth external bus 65. The DCM 91 can wirelessly communicate with a device outside the vehicle 100 via a communication network NW. The term “DCM” is an abbreviation for “Data Communication Module.” The display 92 is connected to the central ECU 10. The display 92 can display various types of information based on image data output from the central ECU 10.

As shown in FIG. 1, the information processing system IS includes a data center 200. An example the data center 200 is a so-called server. The data center 200 includes an execution unit 210, a storage unit 220, and a communication unit 230. The communication unit 230 can communicate with a device outside the data center 200 via the communication network NW.

### Basic Configuration Related to Motion Manager

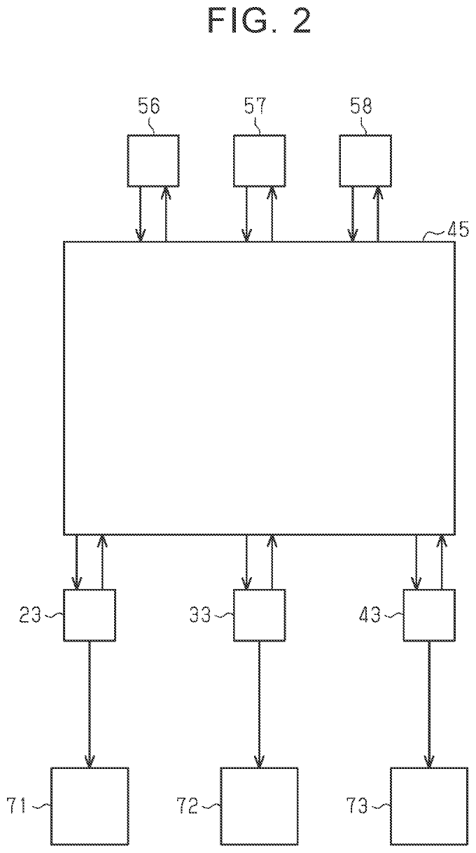

Next, a basic configuration related to the motion manager 45 will be described with reference to FIG. 2. As shown in FIG. 2, the motion manager 45 can communicate with the first assistance unit 56, the second assistance unit 57, and the third assistance unit 58. The motion manager 45 can also communicate with the powertrain control unit 23, the steering control unit 33, and the brake control unit 43.

The first assistance unit 56, the second assistance unit 57, and the third assistance unit 58 output motion requests to the motion manager 45 when performing various types of control. At this time, for example, the first assistance unit 56, the second assistance unit 57, and the third assistance unit 58 continuously output the motion requests from when the various types of control become necessary until such control is no longer needed. The motion requests include a requested longitudinal acceleration GXR for controlling the acceleration along the longitudinal axis of the vehicle 100.

As shown in FIG. 2, the motion manager 45 receives the motion requests from the first assistance unit 56, the second assistance unit 57, and the third assistance unit 58. The motion manager 45 arbitrates the received motion requests. For example, when the motion manager 45 receives requested longitudinal accelerations GXR from a plurality of assistance units, the motion manager 45 selects the earliest received requested longitudinal acceleration GXR as an arbitration result. For example, when the motion manager 45 receives requested longitudinal accelerations GXR from a plurality of assistance units, the motion manager 45 selects the smallest requested longitudinal acceleration GXR as an arbitration result. The motion manager 45 thus arbitrates the motion requests according to a predetermined rule based on the driving condition of the vehicle 100.

The motion manager 45 generates instruction values for action requests to control various actuators based on the arbitration result. The various actuators include the powertrain device 71, the steering system 72, and the brake device 73. For example, when controlling the powertrain device 71, the motion manager 45 outputs an instruction value for an action request to the powertrain control unit 23. The powertrain control unit 23 outputs a control signal to the powertrain device 71 based on the instruction value of the action request. In this way, an instruction value output from the motion manager 45 is received by the control unit corresponding to the actuator to be controlled, and the actuator is controlled by the control unit.

### Driving Force Adjustment Control

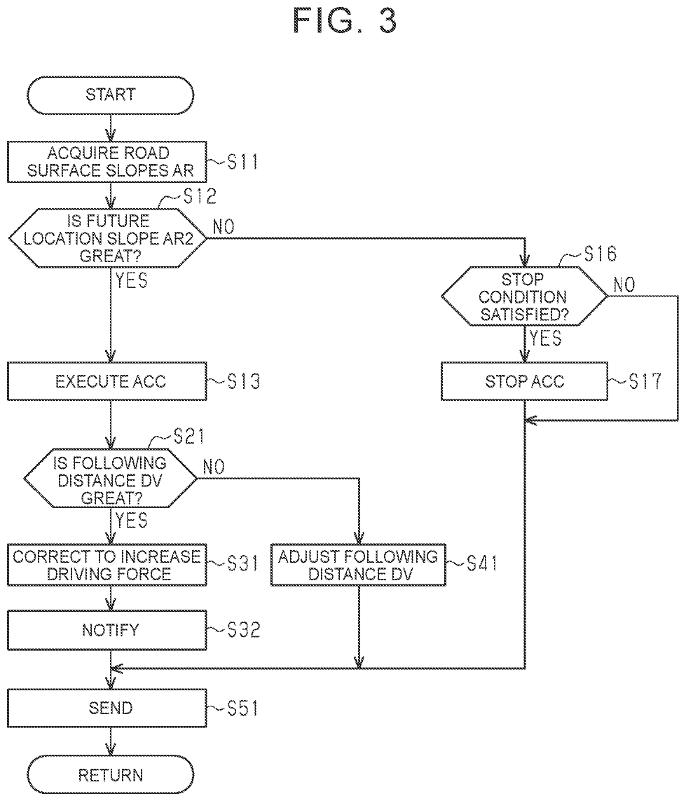

Next, driving force adjustment control that is performed by the motion manager 45 will be described with reference to FIG. 3. In the present embodiment, the motion manager 45 repeatedly performs the driving force adjustment control on the condition that the vehicle 100 is traveling.

As shown in FIG. 3, when the driving force adjustment control is started, the motion manager 45 performs step S11. In step S11, the motion manager 45 acquires road surface slopes AR. The road surface slope AR is a slope of the road surface on which the vehicle 100 travels. In the present embodiment, the motion manager 45 first acquires map data DM from the data center 200. The map data DM includes data on a plurality of road surface slopes AR. The road surface slopes AR are the slopes of the road surface at each point on the road. The motion manager 45 identifies, on the map data DM, the point where the vehicle 100 is located at the time step S11 is performed, that is, the current location of the vehicle 100, based on the location coordinates PC. The motion manager 45 also identifies the road surface slope AR corresponding to the current location of the vehicle 100 from the data on the road surface slopes AR included in the map data DM. The motion manager 45 then acquires a current location slope AR1 based on the identified road surface slope AR and the direction of travel of the vehicle 100. The current location slope AR1 is the slope at the current location of the vehicle 100. When the vehicle 100 is traveling on a road with an uphill slope, the value of the current location slope AR1 is positive. When the vehicle 100 is traveling on a road with a downhill slope, the value of the current location slope AR1 is negative. That is, the sign of the current location slope AR1 changes according to the direction of travel of the vehicle 100. When the vehicle 100 is traveling on a horizontal road, the value of the current location slope AR1 is zero.

In addition, the motion manager 45 identifies, on the map data DM, a point ahead of the current location of the vehicle 100 in the direction of travel of the vehicle 100, namely a future location of the vehicle 100, based on the current location of the vehicle 100 and the direction of travel of the vehicle 100. The motion manager 45 also identifies the road surface slope AR corresponding to the future location of the vehicle 100 from the data on the road surface slopes AR included in the map data DM. The motion manager 45 then acquires a future location slope AR2 based on the identified road surface slope AR and the direction of travel of the vehicle 100. The future location slope AR2 is the slope at the future location of the vehicle 100. Like the current location slope AR1 described above, the future location slope AR2 can be positive, negative, or zero. In the present embodiment, the future location of the vehicle 100 is a point that is a predetermined reference distance away from the current location of the vehicle 100 in the direction of travel of the vehicle 100. An example of the reference distance is several tens of meters. After step S11, the process proceeds to step S12.

In step S12, the motion manager 45 determines whether the future location slope AR2 is greater than the current location slope AR1 by a predetermined value A determined in advance or more. The predetermined value A is a threshold value for determining whether it is necessary to increase the driving force of the vehicle 100 according to a change in road surface slope AR. The predetermined value A is a positive value determined in advance through experiments, simulations, etc. Therefore, for example, when the vehicle 100 is about to proceed from a horizontal road to a road with an uphill slope and the amount of change in slope between the horizontal road and the road with an uphill slope is relatively large, the motion manager 45 determines that the future location slope AR2 is greater than the current location slope AR1 by the predetermined value A or more. For example, when the vehicle 100 is about to proceed from a road with a downhill slope to a horizontal road and the amount of change in slope between the road with a downhill slope and the horizontal road is relatively large, the motion manager 45 determines that the future location slope AR2 is greater than the current location slope AR1 by the predetermined value A or more. In the present embodiment, step S12 is the step of comparing the current location slope AR1 and the future location slope AR2. When the motion manager 45 determines in step S12 that the future location slope AR2 is greater than the current location slope AR1 by the predetermined value A or more (S12: YES), the process proceeds to step S13.

In step S13, the motion manager 45 executes the application software for ACC. Specifically, the motion manager 45 outputs a control signal to the third assistance unit 58. As a result, the driver assistance function of the vehicle 100 by the application software for ACC is implemented When the application software for ACC is already running at the time step S13 is performed, the motion manager 45 keeps the application software for ACC running. As described above, the application software for ACC allows the vehicle 100 to travel while maintaining a constant following distance DV from a preceding vehicle. The application software for ACC also allows the vehicle 100 to travel at a predetermined speed when there is no preceding vehicle. After step S13, the process proceeds to step S21.

In step S21, the motion manager 45 determines whether the following distance DV is equal to or greater than a prescribed distance B determined in advance. In the present embodiment, the motion manager 45 sets the prescribed distance B to a greater value as the speed of the vehicle 100 at the time step S21 is performed is higher. When there is no preceding vehicle traveling ahead of the vehicle 100, the motion manager 45 determines that the following distance DV is equal to or greater than the prescribed distance B. For example, the prescribed distance B is set within a range of several tens of meters to a hundred and several tens of meters.

When the motion manager 45 determines in step S21 that the following distance DV is equal to or greater than the prescribed distance B (S21: YES), the process proceeds to step S31. That is, the process proceeds to step S31 on the condition that the future location slope AR2 is greater than the current location slope AR1 by the predetermined value A or more and that the following distance DV is equal to or greater than the prescribed distance B.

In step S31, the motion manager 45 corrects the driving force of the vehicle 100 so as to increase the driving force of the vehicle 100. Specifically, the motion manager 45 outputs a control signal to the third assistance unit 58. The third assistance unit 58 then increases the requested longitudinal acceleration GXR compared to when step S31 was started. Increasing the requested longitudinal acceleration GXR increases the driving force of the vehicle 100. In the present embodiment, the third assistance unit 58 increases the correction amount of the requested longitudinal acceleration GXR, namely increases the correction amount of the driving force of the vehicle 100, as the absolute value of the difference between the future location slope AR2 and the current location slope AR1 at the time step S12 is performed is greater. After step S31, the process proceeds to step S32. That is, when the motion manager 45 increases the driving force of the vehicle 100 in response to the future location slope AR2 being greater than the current location slope AR1 by the predetermined value A or more, the process proceeds to step S32.

In step S32, the motion manager 45 notifies a user of the vehicle 100 that the driving force of the vehicle 100 is increased. Specifically, the motion manager 45 notifies the user of the vehicle 100 via the display 92 by outputting a control signal to the display 92. For example, the display 92 displays a message saying “Increasing driving force due to slope change.” After step S32, the process proceeds to step S51.

When the motion manager 45 determines in step S21 that the following distance DV is less than the prescribed distance B (S21: NO), the process proceeds to step

S41.

In step S41, the motion manager 45 adjusts the following distance DV to a predetermined fixed distance C. Specifically, the motion manager 45 outputs a control signal to the third assistance unit 58. The third assistance unit 58 adjusts the requested longitudinal acceleration GXR so that the following distance DV becomes the predetermined fixed distance C. For example, the third assistance unit 58 increases the requested longitudinal acceleration GXR when the following distance DV is greater than the fixed distance C. For example, the third assistance unit 58 reduces the requested longitudinal acceleration GXR when the following distance DV is smaller than the fixed distance C. The fixed distance C in step S41 is smaller than the prescribed distance B in step S21. After step S41, the process proceeds to step S51.

When the motion manager 45 determines in step S12 that the future location slope AR2 is not greater than the current location slope AR1 by the predetermined value A or more (S12: NO), the process proceeds to step S16.

In step S16, the motion manager 45 determines whether a predetermined stop condition for stopping the application software for ACC is satisfied. For example, the motion manager 45 determines that the stop condition is satisfied when both of the following requirements (1) and (2) are met.

Requirement (1): The application software for ACC is running. Requirement (2): Execution of the application software for ACC has been started in response to YES in step S12.

Therefore, for example, when execution of the currently running application software for ACC has been started in step S13 of the driving force adjustment control, the motion manager 45 determines that the stop condition is satisfied. On the other hand, for example, when execution of the currently running application software for ACC has been started by an operation performed by the user of the vehicle 100, the motion manager 45 determines that the stop condition is not satisfied.

When the motion manager 45 determines in step S16 that the stop condition is not satisfied (S16: NO), the process proceeds to step S51. On the other hand, when the motion manager 45 determines in step S16 that the stop condition is satisfied (S16: YES), the process proceeds to step S17.

In step S17, the motion manager 45 stops running the application software for ACC. Specifically, the motion manager 45 outputs a control signal to the third assistance unit 58. As a result, the driver assistance function of the vehicle 100 by the application software for ACC is stopped. After step S17, the process proceeds to step S51.

In step S51, the motion manager 45 sends travel data DD to the data center 200. The travel data DD is information associating the slopes at specific points and the driving forces of the vehicle 100 at the specific points. The specific points are points where the vehicle 100 has traveled. In the present embodiment, the travel data DD includes, as the slopes at the specific points, a plurality of current location slopes AR1 acquired in step S11 until a prescribed period before step S51 is performed. The travel data DD includes, as the driving forces of the vehicle 100 at the specific points, a plurality of driving forces of the vehicle 100 corresponding to the current location slopes AR1. An example of the prescribed period is several seconds to several tens of seconds. In the present embodiment, the data center 200 to which the travel data DD is sent is an example of the outside to which the travel data DD is sent. After step S51, the motion manager 45 ends the current driving force adjustment control. The process then returns to step S11.

### Functions of Embodiment

For example, it is assumed that the vehicle 100 is traveling based on motion requests from the third assistance unit 58 while the application software for ACC is running. When the vehicle 100 is traveling in this manner, the motion manager 45 performs the driving force adjustment control as shown in FIG. 3. For example, it is assumed that a situation has occurred in which the vehicle 100 is about to proceed from a horizontal road to a road with an uphill slope and the amount of change in slope between the horizontal road and the road with an uphill slope is relatively large. In this case, the motion manager 45 determines in step S12 whether the future location slope AR2 is greater than the current location slope AR1 by the predetermined value A or more. The process proceeds to step S31 on the condition that the determination result in step S12 is YES. In step S31, the motion manager 45 increases the driving force of the vehicle 100 compared to when step S31 was started.

### Effects of Embodiment

According to the present embodiment, before the road surface slope AR of the road on which the vehicle 100 travels increases, the driving force of the vehicle 100 increases in anticipation of the increase in road surface slope AR. Therefore, the speed of the vehicle 100 is less likely to become excessively low at a point where the road surface slope AR increases. As a result, it is possible to reduce the occurrence of traffic congestion due to a decrease in speed of the vehicle 100.

In the present embodiment, the motion manager 45 proceeds to step S31 on the condition that the future location slope AR2 is greater than the current location slope

AR1 by the predetermined value A or more and that the following distance DV is equal to or greater than the prescribed distance B. Accordingly, the driving force of the vehicle 100 is less likely to increase in a situation where, for example, the following distance DV is less than the prescribed distance B, that is, the following distance DV is relatively small. As the driving force of the vehicle 100 is less likely to increase as described above, the possibility of the following distance DV becoming excessively small can be reduced or eliminated.

When the motion manager 45 increases the driving force of the vehicle 100 in step S31 in response to the future location slope AR2 being greater than the current location slope AR1 by the predetermined value A or more, the process proceeds to step S32. In step S32, the motion manager 45 notifies the user of the vehicle 100 that the driving force of the vehicle 100 is increased. Accordingly, the user of the vehicle 100 is less likely to feel uncomfortable due to the increase in driving force of the vehicle 100 in step S31.

In step S51, the motion manager 45 sends the travel data DD to the data center 200. The travel data DD is information associating the slopes at the specific points, namely the points where the vehicle 100 has traveled, and the driving forces of the vehicle 100 at the specific points. As the travel data DD is repeatedly sent to the data center 200, the data center 200 can collect a large amount of travel data DD. As a result, by analyzing the collected travel data DD, the data center 200 can know a more appropriate value to which the driving force of the vehicle 100 is to be controlled at a specific point.

### Modifications

The above embodiment can be modified as follows. The above embodiment and the following modifications can be combined as long as no technical contradiction arises.

In the above embodiment, the driving force adjustment control may be changed. For example, the condition for performing the driving force adjustment control may be changed. As a specific example, the motion manager 45 may perform the driving force adjustment control on the condition that the vehicle 100 is traveling and that the application software for ACC is running.

For example, the method for acquiring road surface slopes AR in step S11 may be changed. As a specific example, the motion manager 45 may be configured to acquire a road surface slope AR by using LIDAR. The motion manager 45 may be configured to acquire a future location slope AR2, namely the slope at a future location of the vehicle 100, based on the acquired road surface slope AR and the direction of travel of the vehicle 100. The motion manager 45 may be configured to acquire a current location slope AR1, namely the slope at a current location of the vehicle 100, based on the acquired road surface slope AR and the direction of travel of the vehicle 100.

For example, the method for acquiring road surface slopes AR to be used to acquire the current location slope AR1 in step S11 may be changed. As a specific example, the motion manager 45 may identify, at every predetermined control cycle, a road surface slope AR corresponding to a current location of the vehicle 100 based on the longitudinal acceleration GX, the lateral acceleration GY, and the vertical acceleration GZ.

For example, the values to be compared in step S12 may be changed. As a specific example, it may be determined in step S12 whether the current location slope AR1 is greater than a travel point slope AR3 by the predetermined value A or more. As used herein, the travel point slope AR3 refers to the slope at a travel point located in the opposite direction to the direction of travel of the vehicle 100. For example, when this configuration is used, the motion manager 45 acquires a current location slope AR1 at every predetermined control cycle. The motion manager 45 also stores each acquired current location slope AR1 for a certain period determined in advance. An example of the certain period is several seconds to several tens of seconds. In step S11, the motion manager 45 acquires the travel point slope AR3 instead of the future location slope AR2. Specifically, the motion manager 45 identifies, as the travel point, a point located a predetermined reference direction away from the current location of the vehicle 100 in the opposite direction to the direction of travel of the vehicle 100, based on the current location of the vehicle 100 and the direction of travel of the vehicle 100. The motion manager 45 also acquires a travel point slope AR3 corresponding to the identified travel point from the stored data on the current location slopes AR1. An example of the reference distance is several tens of meters. According to this configuration, as the road surface slope AR of the road on which the vehicle 100 travels increases, the driving force of the vehicle 100 increases with the increase in road surface slope AR. Therefore, the speed of the vehicle 100 is less likely to become excessively low at a point where the road surface slope AR increases. As a result, it is possible to reduce the occurrence of traffic congestion due to a decrease in speed of the vehicle 100.

For example, the values to be compared in step S21 may be changed. As a specific example, in step S21, the motion manager 45 may set the prescribed distance B to a fixed value regardless of the speed of the vehicle 100 at the time step S21 is performed.

For example, step S21 may be omitted. As a specific example, the motion manager 45 may proceed to step S31 after step S13. Even if step S21 is omitted, the following distance DV is unlikely to become excessively small. Therefore, omitting step S21 does not have a great impact.

For example, the situation in which the driving force of the vehicle 100 is corrected to be increased in step S31 may be changed. As a specific example, the motion manager 45 may be configured to correct the driving force of the vehicle 100 so as to increase the driving force of the vehicle 100, when the application software for ACC is not running and the driving force of the vehicle 100 is controlled by the operation of an accelerator pedal by the user of the vehicle 100.

For example, step S32 may be omitted. For example, step S32 may be omitted when the user of the vehicle 100 is aware in advance that there is a process of increasing the driving force of the vehicle 100 according to a slope change.

For example, the travel data DD in step S51 may be changed. As a specific example, the travel data DD may include only the current location slope AR1 acquired in the current step S11 as the slope at a specific point. Similarly, the travel data DD may include only the driving force of the vehicle 100 corresponding to this current location slope AR1 as the driving force of the vehicle 100 at the specific point.

As another specific example, the travel data DD may include various types of information such as the speed of the vehicle 100, in addition to or instead of the information associating the slopes at the specific points where the vehicle 100 has traveled and the driving forces of the vehicle 100 at the specific points.

For example, step S51 may be omitted. Step S51 may be omitted if the data center 200 etc. does not analyze the collected travel data DD.

In the above embodiment, the configuration of the vehicle 100 may be changed. For example, the ECU that implements the function of the motion manager 45 may be other than the brake ECU 40. As a specific example, instead of the brake ECU 40, the execution device 11 of the central ECU 10 may implement the function of the motion manager 45 by executing the motion manager application 45A stored in the storage device 12. That is, the central ECU 10, the powertrain ECU 20, the steering ECU 30, the brake ECU 40, and the advanced driver assistance ECU 50 may be configured to be used as a control device for the vehicle 100.

What is claimed is:

1. A control device for a vehicle, the control device comprising a processor configured to:
acquire a slope at a current location, the current location being a point where the vehicle is located;
acquire a slope at a preceding location, the preceding location being a point ahead of the current location in a travel direction of the vehicle;
compare the slope at the current location and the slope at the preceding location; and
increase a driving force of the vehicle on condition that the slope at the preceding location is greater than the slope at the current location by a predetermined value determined in advance or more.

2. The control device according to claim 1, wherein the processor is configured to:
acquire a following distance from the vehicle to a preceding vehicle traveling ahead of the vehicle; and
increase the driving force of the vehicle on condition that the slope at the preceding location is greater than the slope at the current location by the predetermined value or more and that the following distance is equal to or greater than a prescribed distance determined in advance.

3. The control device according to claim 1, wherein the processor is configured to notify a user of the vehicle when increasing the driving force of the vehicle in response to the slope at the preceding location being greater than the slope at the current location by the predetermined value or more.

4. The control device according to claim 1, wherein:
the processor is configured to
associate a slope at a specific point with the driving force of the vehicle at the specific point, and
send information associating the slope at the specific point with the driving force of the vehicle at the specific point to outside; and
the specific point is a point where the vehicle has traveled.

5. A control device for a vehicle, the control device comprising a processor configured to
acquire a slope at a current location, the current location being a point where the vehicle is located,
store the acquired slope at the current location for a certain period determined in advance,
compare the acquired slope at the current location and a slope at a travel point out of the stored slopes at the current locations, the travel point being a point located in an opposite direction to a travel direction of the vehicle, and
increase a driving force of the vehicle on condition that the acquired slope at the current location is greater than the slope at the travel point by a predetermined value determined in advance or more.
